(19) United States
(12) Patent Application Publication
(10) Pub. No.: US 2022/0405535 A1
(43) Pub. Date: Dec. 22, 2022

(54) DATA LOG CONTENT ASSESSMENT USING MACHINE LEARNING

(71) Applicant: International Business Machines Corporation, Armonk, NY (US)

(72) Inventors: Aankur Bhatia, Bethpage, NY (US); Namrata Tolani, Bangalore (IN); Abhishek Basu, Kolkata (IN)

(21) Appl. No.: 17/304,325

(22) Filed: Jun. 18, 2021

(51) Int. Cl. G06K 9/62; G06N 20/10

(52) U.S. Cl. CPC G06K 9/6284; G06K 9/6256; G06N 20/10

(57) ABSTRACT

A computer assesses device log entries. The computer receives a training log entry and an input log entry from a log entry corpus. The computer determines for the training log entry, status indicators respective to the group of log entries, The indicators are based on processing the training log entry with a group of unsupervised Machine Learning models calibrated to identify outliers. The computer assigns an outlier status based on the processing to the training log entry. The computer trains a supervised ML learning model with a data pair of the training log entry and an associated data label representing the assigned outlier status value. The computer processes the input log entry with the supervised ML model to predict an input log classification, and the log classification indicates whether the input log is anomaly. The computer generates an input log entry assessment report including the input log entry classification.

### BACKGROUND

The present invention relates generally to the field of Security Information and Event Management (SIEM) and more specifically, to real-time assessment of device event log content for communicatively connected devices.

Online Managed Security Services (including Security Information and Event Management “SIEM” solutions, etc.) monitor communication between and among connected devices. These services identify communication events that may present threats to any of hundreds or thousands of connected clients. Many of these services apply predefined rules while analyzing large groups of event records (e.g., logs), generating alerts when event log criteria match the rule logic. The systems can be very effective at identifying threats when suitable threat detection rules exist.

Unfortunately, detection rules are often based on known threats and new threats (e.g., zero-day threats) can go undetected (e.g., as false negatives) when no suitable rule has yet been developed. Additionally, while rule-based threat monitors will identify threat patterns occurring within event logs, many events identified as threats (e.g., up to 95% in some domains) actually pose no security threats (e.g. false positives). Although false positives are not typically a security threat, these identified event logs are often stored as a matter of processing, and accumulated storage can become costly (both physically and financially) over time.

Improvements in these threat monitoring systems to reduce false negatives and false positives will increase system security, while reducing overall operating costs.

### SUMMARY

According to one embodiment, a computer-implemented method of device log entry assessment includes receiving, by a computer, a preprocessed training log entry and a preprocessed input log entry from a log entry corpus containing a group of log entries representing data from communicatively connected devices available to the computer. The computer determines for the training log entry a group of outlier status indicators respective to the group of log entries based, at least in part, on processing the training log entry with a corresponding group of unsupervised Machine Learning (ML) learning models each calibrated to identify outliers within the log entry corpus. The computer, responsive to recognizing that at least a threshold quantity of the outlier status indicators are substantially similar, assigs an outlier status based thereupon to the training log entry. The computer trains a supervised ML learning model with a data pair including the training log entry and an associated data label representing the assigned outlier status value. The computer, responsive to the training, processes the input log entry with the supervised ML learning model to predict a log classification for the input log entry, wherein the log classification indicates whether the input log is predicted to represent an anomaly with respect to the group of log entries. The computer generates an input log entry assessment report that includes the input log entry classification. According to aspects of the invention, the computer processes the log entry with a one-class support vector machine (OCSVM) calibrated to consider a Mahalanobis Distance class boundary based, at least in part, on a principal component analysis of the group of log entries to generate a classification confidence rating for the input log entry classification, and the input log entry assessment report includes the classification confidence rating. According to aspects of the invention, the computer determines that at least one statistically significant input log feature occurs with a frequency below a preselected anomaly-indicating occurrence threshold by considering feature occurrence measurements selected from a group consisting of inverse frequency mapping, quantile transformation, and frequency mapping, and the input log entry assessment report includes the statistically significant input log feature. According to aspects of the invention, responsive to assigning the training log entry outlier status, the computer receives outlier status verification input and adjusts the outlier status in accordance therewith, and the outlier status verification input is selected from the group consisting of at least one predetermined assessment rule and log assessment input received from an analyst. According to aspects of the invention, the calibration of the group of unsupervised ML learning models to identify outliers within the log entry corpus accommodates a contamination value selected for each unsupervised ML learning model in accordance with a Mahalanobis Distance based, at least in part, on a principal component analysis of the group of log entries. According to aspects of the invention, the group of unsupervised ML learning models is selected from the group consisting of self-organized maps, isolation forests, auto encoders, and Mahalanobis-distance-based algorithms. According to aspects of the invention, the supervised ML learning model is a random forest model.

According to another embodiment, a system of device log entry assessment includes a computer system comprising a computer readable storage medium having program instructions embodied therewith, the program instructions executable by a computer to cause the computer to: receive a preprocessed training log entry and a preprocessed input log entry from a log entry corpus containing a group of log entries representing data from communicatively connected devices available to the computer; determine for the training log entry a group of outlier status indicators respective to the group of log entries based, at least in part, on processing the training log entry with a corresponding group of unsupervised Machine Learning (ML) learning models each calibrated to identify outliers within the log entry corpus; responsive to recognizing that at least a threshold quantity of the outlier status indicators are substantially similar, assigning an outlier status based thereupon to the training log entry; training a supervised ML learning model with a data pair including the training log entry and an associated data label representing the assigned outlier status value; responsive to the training, processing the input log entry with the supervised ML learning model to predict a log classification for the input log entry, wherein the log classification indicates whether the input log is predicted to represent an anomaly with respect to the group of log entries; and generating an input log entry assessment report that includes the input log entry classification.

According to another embodiment, a computer program product for device log entry assessment, the computer program product comprising a computer readable storage medium having program instructions embodied therewith, the program instructions executable by a computer to cause the computer to: receive, using the computer, a preprocessed training log entry and a preprocessed input log entry from a log entry corpus containing a group of log entries representing data from communicatively connected devices available to the computer; determine, using the computer, for the training log entry a group of outlier status indicators respective to the group of log entries based, at least in part, on processing the training log entry with a corresponding group of unsupervised Machine Learning (ML) learning models each calibrated to identify outliers within the log entry corpus; responsive to recognizing that at least a threshold quantity of the outlier status indicators are substantially similar, assigning, using the computer, an outlier status based thereupon to the training log entry; training, using the computer, a supervised ML learning model with a data pair including the training log entry and an associated data label representing the assigned outlier status value; responsive to the training, processing, using the computer, the input log entry with the supervised ML learning model to predict a log classification for the input log entry, wherein the log classification indicates whether the input log is predicted to represent an anomaly with respect to the group of log entries; and generating, using the computer, an input log entry assessment report that includes the input log entry classification.

The present disclosure recognizes and addresses the shortcomings and problems associated with log assessment and filtering. According to aspects of the invention, event logs are filtered at the ingestion stage, allowing for log prioritization and ingestion/retention based on anomaly score and labelling rationale. Aspects of the invention improve log retention accuracy, reducing log storage costs, enhancing log analytics, and generating fewer false positives.

Aspects of the invention address problems associated with classification and scoring of logged event as “Normal” or “Anomalous” to reduce false positives and false negatives.

Aspects of the invention apply semi-supervised machine learning and graph analytics techniques to identify abnormal traffic and provides reasoning for anomalies observed.

Aspects of the invention provide threat detection capabilities suitable to address singular attacks or malicious events that are very spaced apart (e.g., “low and slow” attacks often missed by traditional, rules-based STEM systems.

Aspects of the present invention promote prioritized log intake, reducing false positive indications and improving overall system performance.

Aspects of the invention provide an end-to-end, semi-supervised machine learning system that uses a machine learning pipeline including a cooperative arrangement of unsupervised and supervised classifiers, in which data output and assessment results are passed forward (e.g., among classifiers) through the pipeline.

Aspects of the present invention include pre-processing logic including feature extraction, feature engineering and feature selection. In an embodiment, data is extracted using an application programming interface “API” and stored temporarily (e.g., in a database).

Aspects of the invention apply a graph database in the backend to extract additional features built on relationships and community detection algorithms revealed by the graph database.

Aspects of the invention apply log status verification input (e.g., input from analysts and Subject Matter Experts “SMEs”) via a rules engine. In an embodiment, the rules are applied to confirm (or override) a majority vote result (or other selected threshold) generated by a group (e.g., four or other selected quantity) of unsupervised machine learning models. In an embodiment, the input may be considered relevant ground truth and is provided before feeding the “majority vote” log status into a downstream supervised machine learning phase.

According to aspects of the invention, a scoring model (e.g. a One Class SVM “OCSVM” classifier) is applied “on top of” results from a supervised machine learning phase. In an embodiment, the pipeline evaluation models are accessed through a web API layer. Every log is scored, labeled and classified with a categorization decision rationale (including, in some cases, uncommon events or combinations of log elements identified as “rare events”) for identifying log entries as anomalous.

Aspects of the invention provide data extraction, data preprocessing & feature engineering, unsupervised anomaly detection models, and status confirming (or overriding) input. Other aspects of the invention provide supervised machine learning models, an ensemble model for classification confidence (e.g., score) generation, and log entry classification rationale).

Aspects of the invention include unsupervised and supervised classifiers.

Aspects of the invention identifies graph relationship features (e.g., via community detection, page rank, and label propagation algorithms). In an embodiment, aspects of the invention use a graph database in the backend to combines features identified through graph visualizations with other engineered features.

Aspects of the invention accommodate a contamination factor (e.g., likely anomalies) calculated using a Mahalanobis Distance algorithm on Primary Component Analysis (PCA) data (explaining 90% variance). In an embodiment, the contamination factor is passed to unsupervised machine learning models (e.g., including Isolation forest (IF), Self-Organizing Maps (SOM) and Autoencoder (AE) classifiers). According to aspects of the invention, the contamination factor provides a calibration seed passed through several algorithms. According to aspects of the invention, results of several unsupervised ML models are combined through a majority voting algorithm.

Aspects of the invention provide a log classification rationale that identifies log features (or feature combinations) that are uncommon (e.g., not seen previously, seen only rarely, etc.), as novel features (or feature combinations) often indicate security threats.

Aspects of the invention classify and score every log event as ‘Normal’ or ‘Anomalous’

Aspects of the invention use semi-supervised machine learning and graph analytics techniques to identify abnormal traffic and provides reasoning (e.g., classification rationale) for anomalies observed.

Aspects of the invention prioritize SIEM log ingestion, thereby improving overall system performance and reducing false positive log indications.

Aspects of the invention provide an end-to-end, semi-supervised machine learning system that includes multiple unsupervised classifiers and one supervised classifier ensembled to pass analysis output among models within a model analysis pipeline.

Aspects of the invention provide pre-processing logic that includes feature extraction, feature engineering, and feature selection.

Aspects of the invention extract log data via an Application Programming Interface (API), store the extracted data in a relational database, and apply a backend graph database to extract additional features built on relationships and community detection algorithms.

Aspects of the invention identify feature relationships via community detection, page rank, and label propagation algorithms using a backend graph database and combine these graph database-based relationships it with other engineered features.

Aspects of the invention incorporate analyst and subject matter Expert (SME) feedback input applied through a rule engine to unsupervised classifier group majority voting logic output.

Aspects of the invention calculate an unsupervised Machine Learning (ML) models contamination factor (e.g., likely anomalies) using Mahalanobis distance algorithm on PCA data (explaining 90% variance), propagate this contamination factor to a group of unsupervised ML models (e.g., including Isolation forest (IF), Self-Organizing Maps (SOM) and Autoencoder (AE) classifiers).

Aspects of the invention apply status verification input at a supervised learning stage and indicate an assessment score (e.g., confidence rating) via application of a One-Class Support Vector Machine (OCSVM) model.

Aspects of the invention provide, for each log processed, a confidence rating and indications of “rare event” that occur with a frequency below a statistically-significant threshold (e.g., in fewer than 0.003%, or some other values selected by on skilled in this field as indicating a “rare” occurrence) of logs and providing a detailed classification rationale (e.g., explainable reasoning for classifying a log as anomalous).

Aspects of the invention filter logs at an ingestion layer, allowing for log prioritization, ingestion, and storage based on anomaly confidence scores and classification rationale).

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. The drawings are set forth as below as:

FIG. 1 is a schematic block diagram illustrating an overview of a system to classify device log entries using machine learning according to embodiments of the present invention.

FIG. 2 is a flowchart illustrating a method, implemented using the system shown in FIG. 1, of a system to classify device log entries using machine learning according to aspects of the invention.

FIG. 3 is a schematic representation of aspects of a method, implemented using the system shown in FIG. 1, of a system to classify device log entries using machine learning according to embodiments of the present invention.

FIG. 4A is a schematic representation of aspects of a method, implemented using the system shown in FIG. 1, of a system to classify device log entries using machine learning according to embodiments of the present invention.

FIG. 4B is a schematic representation of aspects of a method, implemented using the system shown in FIG. 1, of a system to classify device log entries using machine learning according to embodiments of the present invention.

FIG. 5 is a schematic representation of aspects of a method, implemented using the system shown in FIG. 1, of a system to classify device log entries using machine learning according to embodiments of the present invention.

FIG. 6 is a schematic block diagram depicting a computer system according to an embodiment of the disclosure which may be incorporated, all or in part, in one or more computers or devices shown in FIG. 1, and cooperates with the systems and methods shown in FIG. 1.

FIG. 7 depicts a cloud computing environment according to an embodiment of the present invention.

FIG. 8 depicts abstraction model layers according to an embodiment of the present invention.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a participant” includes reference to one or more of such participants unless the context clearly dictates otherwise.

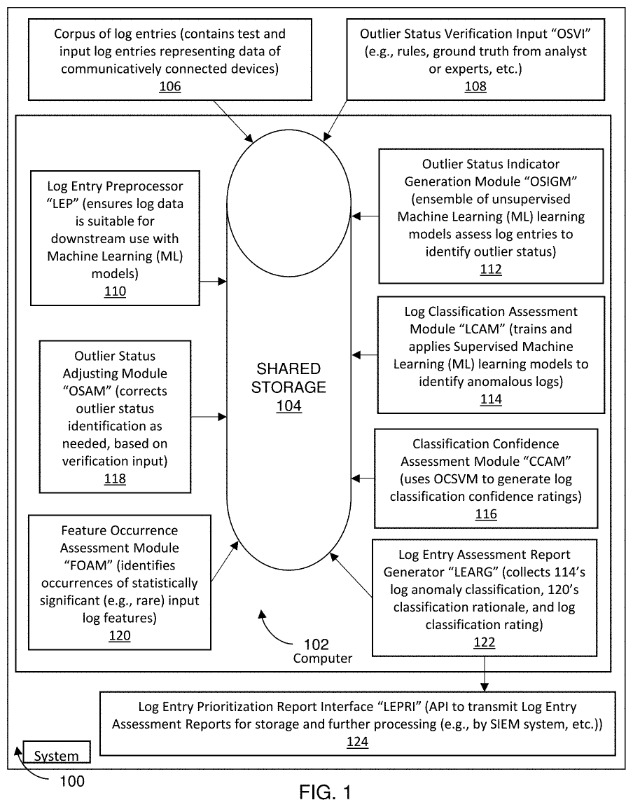

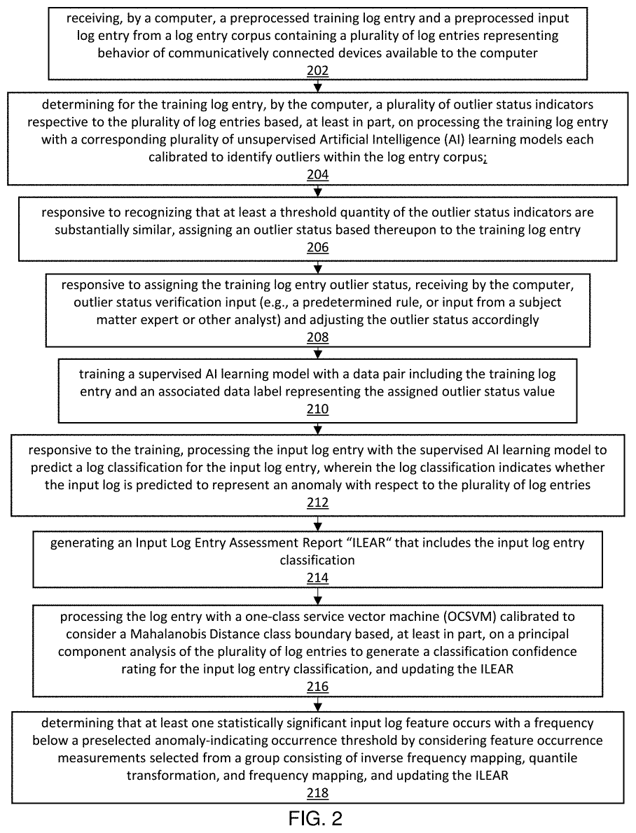

Now with combined reference to the Figures generally and with particular reference to FIG. 1 and FIG. 2, an overview of a method of classifying device log entries using machine learning usable within a system 100 as carried out by a server computer 102 having optionally shared storage 104.

The server computer 102 is in communication with a corpus of log entries 106 that contains test and input log entries representing data of communicatively connected devices.

The server computer 102 is in communication with a source of outlier status verification input 108 (e.g., rules, ground truth from analyst or experts, etc.). The server computer 102 includes a Log Entry Preprocessor “LEP” 110 that ensures log data is suitable for use with downstream Machine Learning (ML) models.

The server computer 102 includes Outlier Status Indicator Generation Module “OSIGM” 112 that includes an ensemble of unsupervised Machine Learning (ML) learning models that assess log entries to identify outlier status.

The server computer 102 includes Log Classification Assessment Module “LCAM” 114 that trains and applies supervised Machine Learning (ML) learning models to identify anomalous logs (e.g., logs likely to represent threats).

The server computer 102 includes Classification Confidence Assessment Module “CCAM” 116 that uses a One-Class Support Vector Machine (OCSVM) algorithm to generate log classification confidence ratings (e.g., by indicating a degree of “out-of-classness” for a given log), which in combination with a classification rationale (also provided by aspects of the present invention) that indicates elements (e.g., log features or feature combinations) are likely anomalous, provide increased explainability and improved confidence in log anomaly status predictions when generated.

The server computer 102 includes Outlier Status Adjusting Module “OSAM” 118 that corrects outlier status identifications as needed, based on status verification input 108 received by the server computer. In an embodiment, during operation, the server computer 102 considers the status verification input 108 to be ground truth and when a ML classification prediction is contrary to this input, the classification may be automatically overridden to match the ground truth. However, to address new threats, aspects of the present may note the conflicting status and flag the conflicting log for further assessment, expert follow-up, etc.

The server computer 102 includes Feature Occurrence Assessment Module “FOAM” 120 that identifies occurrences of statistically significant input log features, making them available for inclusion in log entry assessment reports described more fully below.

The server computer 102 includes Log Entry Assessment Report Generator “LEARG” 122 that provides log anomaly classification, classification rationale, log priority status, and other log analysis details available to provide assessment context and increase analysis explainability and user confidence regarding the predicted log status.

The server computer 102 is in communication with Log Entry Prioritization Report Interface “LEPRI” 124 (e.g., a fast API) that transmits Log Entry Assessment Reports to a STEM (or other suitable system selected by one skilled in this field) for storage and further processing. In an embodiment, the log entry assessment reports containing input log anomaly classification, classification rationale, and log priority status. According to aspects of the invention, log entry assessment reports increase prediction explainability, increase end user prediction confidence, and are considered when selecting logs for ingestion, storage, and further processing.

Now with specific reference to FIG. 2, and to other figures generally, a computer-implemented method for classifying device log entries using machine learning with the system 100 will be discussed. The server computer 102 at block 202 receives a training log entry and an input log entry from a log entry corpus containing a group of log entries representing behavior of communicatively connected devices available to the computer. It is noted the corpus of log entries may contain training logs as well as input data which is to be processed during end user application of aspects of the present invention. In an embodiment, the server computer extracts log data from the log data corpus through use of associated Application Program Interfaces “APIs” (e.g., File Search and File Read APIs), and returned log data is held in a relational database (e.g., a database accessible through Structured Query Language “SQL” calls). In an embodiment, the server computer 102 conducts log data preprocessing via Log Entry Preprocessor “LEP” 110. According to aspects of the invention, preprocessing and feature engineering take place over several stages. In an embodiment, the LEP 110 conducts feature extraction, to identify relevant and apply feature enrichments. According to aspects of the invention, the LEP 110 conducts feature transformation, which includes encoding of nominals, inverse frequency mapping, and quantile encoding. In an embodiment, the server computer 102 undertakes graph database analysis (e.g., including node interconnectivity assessment, community detection, and application of label propagation graph algorithms) to identify log features that represent relationships between the nodes and associated communities. According to aspects the LEP 110 also conducts feature selection and feature scaling. In an embodiment, the server computer 102 also provides assessment rationale and indications of rare (e.g., occurring in fewer than 0.003% of cases in the corpus 106, or other frequency selected by one skilled in this field to indicate statistical significance) events (e.g., log data associated with certain features or combinations), as determined by aspects of the present invention.

The server computer 102, via Outlier Status Indicator Generation Module “OSIGM” 112 at block 204, determines for the training log entry, a group of outlier status indicators respective to the group of log entries. According to aspects of the invention, the OSIGM 112 passes the training log entry through a group (e.g., four or other quantity selected by one of skill in this field) of unsupervised Machine Learning (ML) models each calibrated to identify outliers within the log entry corpus, and each ML model independently classifies the log entry as either “anomalous” or “normal.” In an embodiment, the preferred unsupervised ML models are self-organizing maps, isolation forests, deep learning auto encoders, and Mahalanobis-distance-based classifiers; however, alternatives may be selected according to the judgment of one skilled in this field.

According to aspects of the invention, the server computer 102 via OSIGM 112 at block 206, responsive to recognizing that at least a threshold quantity of the outlier status indicators are substantially similar assigns an outlier status based thereupon to the training log entry. In particular, the OSIGM 112 notes analysis results and identifies when a majority (or other preselected threshold quantity) of unsupervised model match and the log is temporarily classified based on the majority analysis (e.g., given the majority label).

The server computer 102 via Outlier Status Adjusting Module “OSAM” 118 at block 208, responsive to the assigning the training log entry outlier status, receives Outlier Status Verification Input “OSVI” 108 (e.g., a predetermined rule, expert or analyst input) and adjusts the log entry outlier status as needed. According to aspects of the invention, the server computer 102 considers, prior to application of the supervised ML model, whether the OSVI 108 contradicts the majority-vote-indicated log status and corrects the training log outlier status value accordingly.

The server computer 102 via Log Classification Assessment Module “LCAM” 114 at block 210 trains a supervised AI learning model with a data pair including the training log entry and an associated data label representing the assigned log entry outlier status value. According to aspects of the invention, after obtaining majority voting output from OSIGM 112, the server computer 102 uses the majority output (correcting for outlier status verification input via OSAM 118 as needed) as part of a training pair dataset to train a Random Forest Classifier.

The server computer 102, via further operation of LCAM 114 at block 212, in response to the model training in block 212, processes the input log entry with the supervised AI learning model and classifies the input log entry. According to aspects of the invention, the log classification indicates whether the input log is deemed to represent an anomaly with respect to the group of log entries.

The server computer 102 via Log Entry Assessment Report Generator “LEARG” 122 at block 214, generates an Input Log Entry Assessment Report “ILEAR.” In an embodiment, the LEARG 122 includes the input log entry classification generated at block 212.

The server computer 102 via Classification Confidence Assessment Module “CCAM” 116 at block 216, processes the log entry with a one-class service vector machine (OCSVM). In an embodiment, the OCSVM is calibrated to consider a Mahalanobis Distance class boundary that is based, at least in part, on a principal component analysis of the group of log entries to generate a classification confidence rating (e.g., by indicating a degree of “out-of-classness”) for the input log entry classification. In an embodiment, the server computer 102 updates the ILEAR to include the classification confidence rating.

The server computer 102 via Feature Occurrence Assessment Module “FOAM” 120 at block 218 determines that at least one statistically significant input log feature occurs with a frequency below a preselected anomaly-indicating occurrence threshold by considering feature occurrence measurements selected from a group consisting of inverse frequency mapping, quantile transformation, and frequency mapping. In an embodiment, the server computer 102 updates the ILEAR to identify the statistically significant input log feature as a rationale for classification. According to aspects of the invention, the rationale indicates the occurrence of rare feature or combination of features. In an embodiment, the FOAM 120 determines the “rareness” of a feature (or combination of features) through frequency mapping, quantile transformation, and threshold validation.

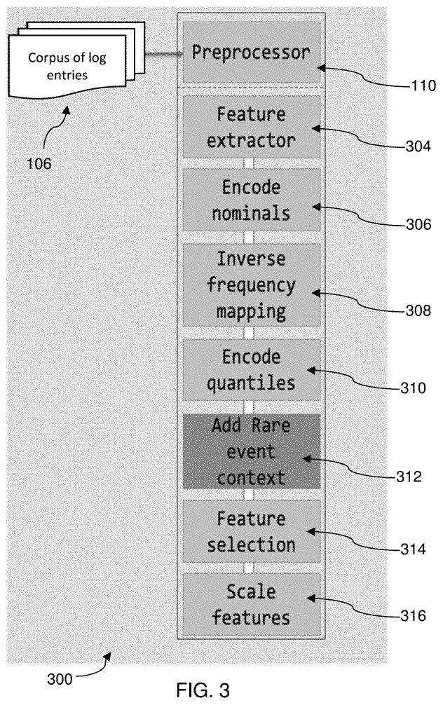

Now with particular reference to FIG. 3, aspects 300 of the interaction between the corpus of log entries 106 and the preprocessor operation of the LPAM 116 will be discussed. The server computer 102 initiates log feature extraction at block 304. The server computer 102 initiates log feature nominals encoding log at block 306. The server computer 102 initiates quantifies log features via inverse frequency mapping at block 308. The server computer 102 initiates log feature quantile encoding at block 310. The server computer 102 appends rare event contexts at block 312. The server computer 102 initiates log feature selection at block 304. The server computer 102 initiates feature scaling at block 304.

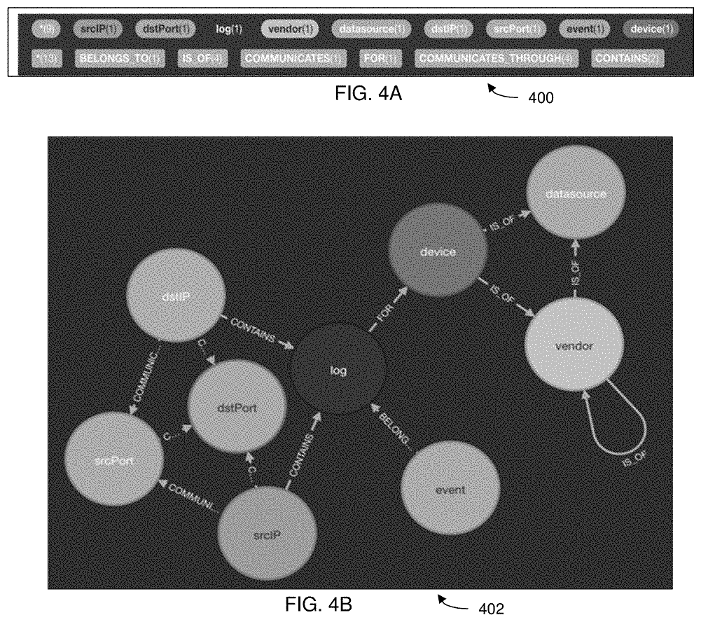

Now with particular reference to FIG. 4A and FIG. 4B, collectively, aspects of the graph database contents are shown in FIG. 4A as a schematic collection 400 and in FIG. 4A as an interconnected web 402. According to aspects of the invention, rounded shapes identify entity nodes, while rectangular shapes and arrows identify relationship edges.

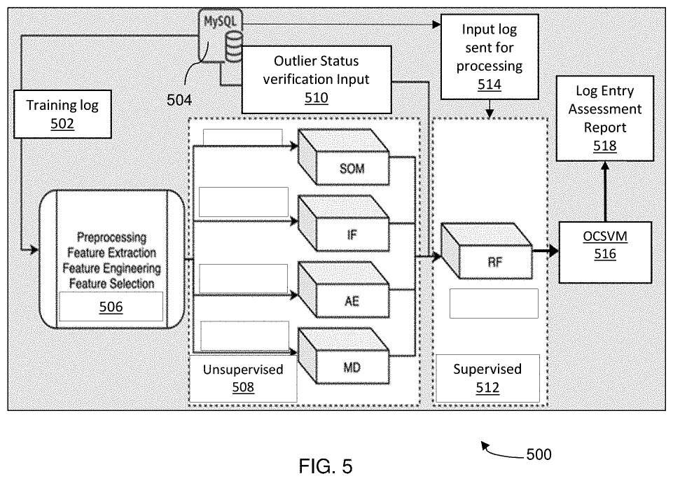

Now with particular reference to FIG. 5, a schematic representation 500 of aspects of a method, implemented using the system shown in FIG. 1, of a system to classify device log entries using machine learning according to embodiments of the present invention will be discussed. At block 502, the server computer 102 receives training logs from a database source 504. The server computer 102 at block 506 initiates log preprocessing (including feature extraction, feature engineering, and feature selection). The server computer 102, at block 508 passes the preprocessed log through a group of unsupervised ML models (e.g., self-organizing maps, isolation forests, auto-encoders, and Mahalanobis distance-based classifiers) to classify the log, using Outlier status verification input 108 a majority vote logic. The sever computer 102 at block 510 confirms (or overrides) the log classification using outlier status verification input 108 and passes the confirmed (or corrected) log assessment (e.g., as part of a training data pair associated with the classified training log) to the supervised Machine Learning (ML) model (e.g., a random forest model) in preparation for assessing input log data. The server computer 102 receives at block 512 (e.g., via an SWL call to database at block 504) an input log for processing. The server computer 102 passes the input log to the supervised ML model at block 512) to classify the input log as either normal or anomalous. The input log is passed along to a one-class support vector machine classifier at block 516 to determine a confidence score (e.g., an indication of “in-class” or “out-of-class” associated with the input log entry compared to the other logs in the corpus of logs). The server computer 102 passes generates, at block 518 a Log Entry Assessment Report “LEAR” that provides details of the assessed log classification to improve explainability of the classification (e.g., normal or anomalous) and overall user confidence. According to aspects of the invention, the LEAR is made available (e.g., via FastAPI-based interface) to a larger SIEM (or other selected system) to facilitate prioritized log retention and further processing.

Regarding the flowcharts and block diagrams, the flowchart and block diagrams in the Figures of the present disclosure illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

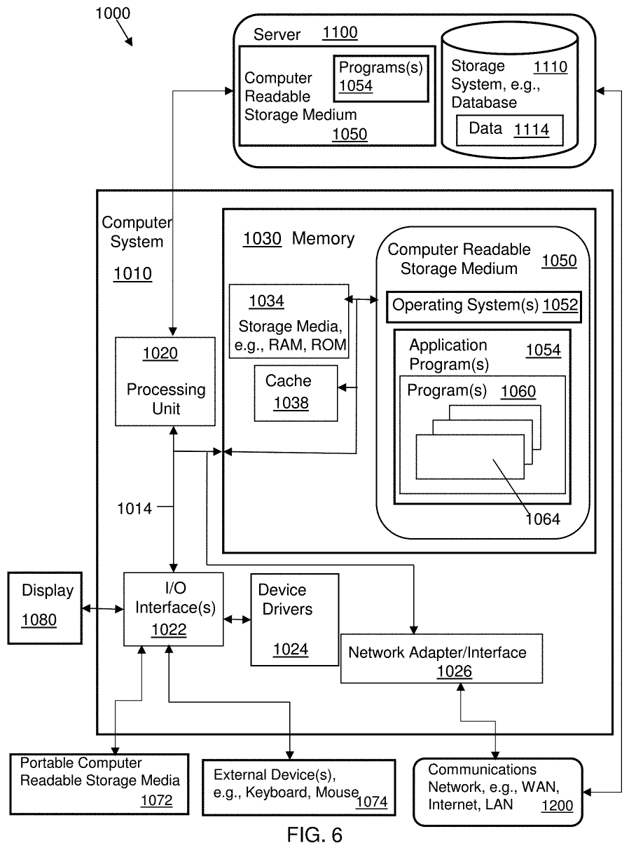

Referring to FIG. 6, a system or computer environment 1000 includes a computer diagram 1010 shown in the form of a generic computing device. The method of the invention, for example, may be embodied in a program 1060, including program instructions, embodied on a computer readable storage device, or computer readable storage medium, for example, generally referred to as memory 1030 and more specifically, computer readable storage medium 1050. Such memory and/or computer readable storage media includes non-volatile memory or non-volatile storage. For example, memory 1030 can include storage media 1034 such as RAM (Random Access Memory) or ROM (Read Only Memory), and cache memory 1038. The program 1060 is executable by the processor 1020 of the computer system 1010 (to execute program steps, code, or program code). Additional data storage may also be embodied as a database 1110 which includes data 1114. The computer system 1010 and the program 1060 are generic representations of a computer and program that may be local to a user, or provided as a remote service (for example, as a cloud based service), and may be provided in further examples, using a website accessible using the communications network 1200 (e.g., interacting with a network, the Internet, or cloud services). It is understood that the computer system 1010 also generically represents herein a computer device or a computer included in a device, such as a laptop or desktop computer, etc., or one or more servers, alone or as part of a datacenter. The computer system can include a network adapter/interface 1026, and an input/output (I/O) interface(s) 1022. The I/O interface 1022 allows for input and output of data with an external device 1074 that may be connected to the computer system. The network adapter/interface 1026 may provide communications between the computer system a network generically shown as the communications network 1200.

The computer 1010 may be described in the general context of computer system-executable instructions, such as program modules, being executed by a computer system. Generally, program modules may include routines, programs, objects, components, logic, data structures, and so on that perform particular tasks or implement particular abstract data types. The method steps and system components and techniques may be embodied in modules of the program 1060 for performing the tasks of each of the steps of the method and system. The modules are generically represented in the figure as program modules 1064. The program 1060 and program modules 1064 can execute specific steps, routines, sub-routines, instructions or code, of the program.

The method of the present disclosure can be run locally on a device such as a mobile device, or can be run a service, for instance, on the server 1100 which may be remote and can be accessed using the communications network 1200. The program or executable instructions may also be offered as a service by a provider. The computer 1010 may be practiced in a distributed cloud computing environment where tasks are performed by remote processing devices that are linked through a communications network 1200. In a distributed cloud computing environment, program modules may be located in both local and remote computer system storage media including memory storage devices.

The computer 1010 can include a variety of computer readable media. Such media may be any available media that is accessible by the computer 1010 (e.g., computer system, or server), and can include both volatile and non-volatile media, as well as, removable and non-removable media. Computer memory 1030 can include additional computer readable media in the form of volatile memory, such as random access memory (RAM) 1034, and/or cache memory 1038. The computer 1010 may further include other removable/non-removable, volatile/non-volatile computer storage media, in one example, portable computer readable storage media 1072. In one embodiment, the computer readable storage medium 1050 can be provided for reading from and writing to a non-removable, non-volatile magnetic media. The computer readable storage medium 1050 can be embodied, for example, as a hard drive. Additional memory and data storage can be provided, for example, as the storage system 1110 (e.g., a database) for storing data 1114 and communicating with the processing unit 1020. The database can be stored on or be part of a server 1100. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1014 by one or more data media interfaces. As will be further depicted and described below, memory 1030 may include at least one program product which can include one or more program modules that are configured to carry out the functions of embodiments of the present invention.

The method(s) described in the present disclosure, for example, may be embodied in one or more computer programs, generically referred to as a program 1060 and can be stored in memory 1030 in the computer readable storage medium 1050. The program 1060 can include program modules 1064. The program modules 1064 can generally carry out functions and/or methodologies of embodiments of the invention as described herein. The one or more programs 1060 are stored in memory 1030 and are executable by the processing unit 1020. By way of example, the memory 1030 may store an operating system 1052, one or more application programs 1054, other program modules, and program data on the computer readable storage medium 1050. It is understood that the program 1060, and the operating system 1052 and the application program(s) 1054 stored on the computer readable storage medium 1050 are similarly executable by the processing unit 1020. It is also understood that the application 1054 and program(s) 1060 are shown generically, and can include all of, or be part of, one or more applications and program discussed in the present disclosure, or vice versa, that is, the application 1054 and program 1060 can be all or part of one or more applications or programs which are discussed in the present disclosure.

One or more programs can be stored in one or more computer readable storage media such that a program is embodied and/or encoded in a computer readable storage medium. In one example, the stored program can include program instructions for execution by a processor, or a computer system having a processor, to perform a method or cause the computer system to perform one or more functions.

The computer 1010 may also communicate with one or more external devices 1074 such as a keyboard, a pointing device, a display 1080, etc.; one or more devices that enable a user to interact with the computer 1010; and/or any devices (e.g., network card, modem, etc.) that enables the computer 1010 to communicate with one or more other computing devices. Such communication can occur via the Input/Output (I/O) interfaces 1022. Still yet, the computer 1010 can communicate with one or more networks 1200 such as a local area network (LAN), a general wide area network (WAN), and/or a public network (e.g., the Internet) via network adapter/interface 1026. As depicted, network adapter 1026 communicates with the other components of the computer 1010 via bus 1014. It should be understood that although not shown, other hardware and/or software components could be used in conjunction with the computer 1010. Examples, include, but are not limited to: microcode, device drivers 1024, redundant processing units, external disk drive arrays, RAID systems, tape drives, and data archival storage systems, etc.

It is understood that a computer or a program running on the computer 1010 may communicate with a server, embodied as the server 1100, via one or more communications networks, embodied as the communications network 1200. The communications network 1200 may include transmission media and network links which include, for example, wireless, wired, or optical fiber, and routers, firewalls, switches, and gateway computers. The communications network may include connections, such as wire, wireless communication links, or fiber optic cables. A communications network may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. A network may also include a number of different types of networks, such as, for example, an intranet, a local area network (LAN), or a wide area network (WAN).

In one example, a computer can use a network which may access a website on the Web (World Wide Web) using the Internet. In one embodiment, a computer 1010, including a mobile device, can use a communications system or network 1200 which can include the Internet, or a public switched telephone network (PSTN) for example, a cellular network. The PSTN may include telephone lines, fiber optic cables, transmission links, cellular networks, and communications satellites. The Internet may facilitate numerous searching and texting techniques, for example, using a cell phone or laptop computer to send queries to search engines via text messages (SMS), Multimedia Messaging Service (MMS) (related to SMS), email, or a web browser. The search engine can retrieve search results, that is, links to websites, documents, or other downloadable data that correspond to the query, and similarly, provide the search results to the user via the device as, for example, a web page of search results.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

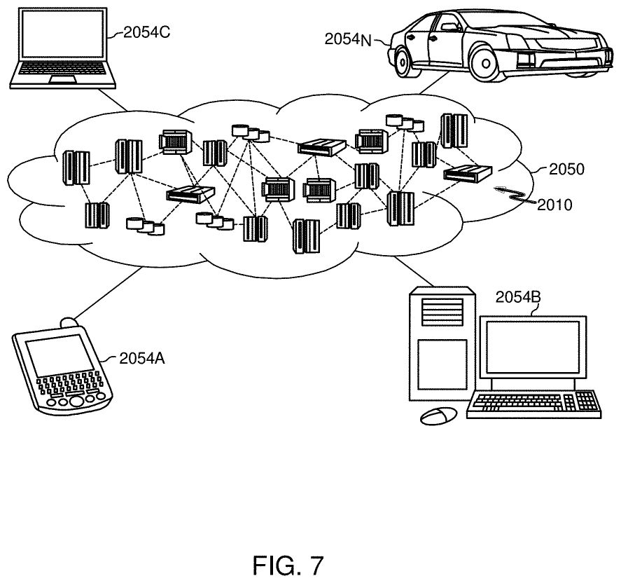

Referring now to FIG. 7, illustrative cloud computing environment 2050 is depicted. As shown, cloud computing environment 2050 includes one or more cloud computing nodes 2010 with which local computing devices used by cloud consumers, such as, for example, personal digital assistant (PDA) or cellular telephone 2054A, desktop computer 2054B, laptop computer 2054C, and/or automobile computer system 2054N may communicate. Nodes 2010 may communicate with one another. They may be grouped (not shown) physically or virtually, in one or more networks, such as Private, Community, Public, or Hybrid clouds as described hereinabove, or a combination thereof. This allows cloud computing environment 2050 to offer infrastructure, platforms and/or software as services for which a cloud consumer does not need to maintain resources on a local computing device. It is understood that the types of computing devices 2054A-N shown in FIG. 7 are intended to be illustrative only and that computing nodes 2010 and cloud computing environment 2050 can communicate with any type of computerized device over any type of network and/or network addressable connection (e.g., using a web browser).

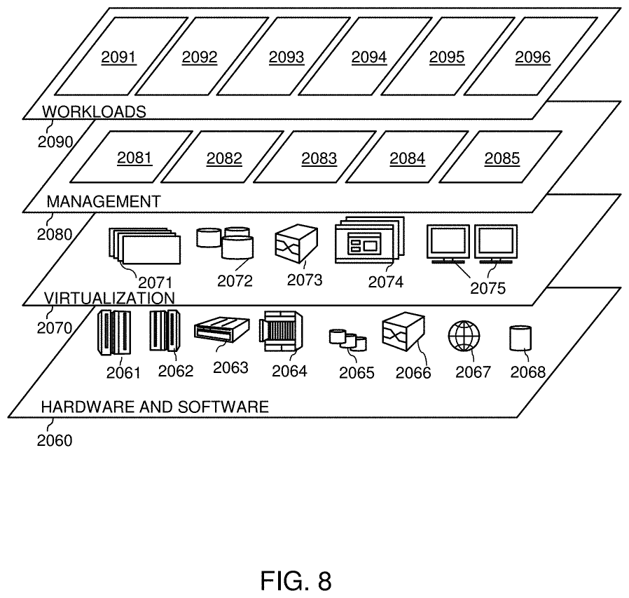

Referring now to FIG. 8, a set of functional abstraction layers provided by cloud computing environment 2050 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 2060 includes hardware and software components. Examples of hardware components include: mainframes 2061; RISC (Reduced Instruction Set Computer) architecture based servers 2062; servers 2063; blade servers 2064; storage devices 2065; and networks and networking components 2066. In some embodiments, software components include network application server software 2067 and database software 2068.

Virtualization layer 2070 provides an abstraction layer from which the following examples of virtual entities may be provided: virtual servers 2071; virtual storage 2072; virtual networks 2073, including virtual private networks; virtual applications and operating systems 2074; and virtual clients 2075.

In one example, management layer 2080 may provide the functions described below. Resource provisioning 2081 provides dynamic procurement of computing resources and other resources that are utilized to perform tasks within the cloud computing environment. Metering and Pricing 2082 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 2083 provides access to the cloud computing environment for consumers and system administrators. Service level management 2084 provides cloud computing resource allocation and management such that required service levels are met. Service Level Agreement (SLA) planning and fulfillment 2085 provide pre-arrangement for, and procurement of, cloud computing resources for which a future requirement is anticipated in accordance with an SLA.

Workloads layer 2090 provides examples of functionality for which the cloud computing environment may be utilized. Examples of workloads and functions which may be provided from this layer include: mapping and navigation 2091; software development and lifecycle management 2092; virtual classroom education delivery 2093; data analytics processing 2094; transaction processing 2095; and classify device log entries using machine learning 2096.

The descriptions of the various embodiments of the present invention have been presented for purposes of illustration, but are not intended to be exhaustive or limited to the embodiments disclosed. Likewise, examples of features or functionality of the embodiments of the disclosure described herein, whether used in the description of a particular embodiment, or listed as examples, are not intended to limit the embodiments of the disclosure described herein, or limit the disclosure to the examples described herein. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer implemented method of device log entry assessment, comprising:
receiving, by a computer, a preprocessed training log entry and a preprocessed input log entry from a log entry corpus containing a group of log entries representing data from communicatively connected devices available to the computer;
determining for the training log entry, by the computer, a group of outlier status indicators respective to the group of log entries based, at least in part, on processing the training log entry with a corresponding group of unsupervised Machine Learning (ML) learning models each calibrated to identify outliers within the log entry corpus;
responsive to recognizing that at least a threshold quantity of the outlier status indicators are substantially similar, assigning by the computer, an outlier status based thereupon to the training log entry;
training, by the computer, a supervised ML learning model with a data pair including the training log entry and an associated data label representing the assigned outlier status value;
responsive to the training, processing by the computer, the input log entry with the supervised ML learning model to predict a log classification for the input log entry, wherein the log classification indicates whether the input log is predicted to represent an anomaly with respect to the group of log entries; and
generating, by the computer, an input log entry assessment report that includes the input log entry classification.

2. The method of claim 1, further including processing, by the computer, the log entry with a one-class support vector machine (OCSVM) calibrated to consider a Mahalanobis Distance class boundary based, at least in part, on a principal component analysis of the group of log entries to generate a classification confidence rating for the input log entry classification; and
wherein the input log entry assessment report includes the classification confidence rating.

3. The method of claim 1, further including determining, by the computer, that at least one statistically significant input log feature occurs with a frequency below a preselected anomaly-indicating occurrence threshold by considering feature occurrence measurements selected from a group consisting of inverse frequency mapping, quantile transformation, and frequency mapping; and
wherein the input log entry assessment report includes the statistically significant input log feature.

4. The method of claim 1, further including, responsive to assigning the training log entry outlier status, receiving by the computer, outlier status verification input and adjusting the outlier status in accordance therewith, wherein the outlier status verification input is selected from the group consisting of at least one predetermined assessment rule and log assessment input received from an analyst.

5. The method of claim 1, wherein the calibration of the group of unsupervised ML learning models to identify outliers within the log entry corpus accommodates a contamination value selected for each unsupervised ML learning model in accordance with a Mahalanobis Distance based, at least in part, on a principal component analysis of the group of log entries.

6. The method of claim of 1, wherein the group of unsupervised ML learning models is selected from the group consisting of self-organized maps, isolation forests, auto encoders, and Mahalanobis-distance-based algorithms.

7. The method of claim 1, wherein the supervised ML learning model is a random forest model.

8. A system of device log entry assessment, which comprises:
a computer system comprising a computer readable storage medium having program instructions embodied therewith, the program instructions executable by a computer to cause the computer to:
receive a preprocessed training log entry and a preprocessed input log entry from a log entry corpus containing a group of log entries representing data from communicatively connected devices available to the computer;
determine for the training log entry a group of outlier status indicators respective to the group of log entries based, at least in part, on processing the training log entry with a corresponding group of unsupervised Machine Learning (ML) learning models each calibrated to identify outliers within the log entry corpus;
responsive to recognizing that at least a threshold quantity of the outlier status indicators are substantially similar, assigning an outlier status based thereupon to the training log entry;
training a supervised ML learning model with a data pair including the training log entry and an associated data label representing the assigned outlier status value;
responsive to the training, processing the input log entry with the supervised ML learning model to predict a log classification for the input log entry, wherein the log classification indicates whether the input log is predicted to represent an anomaly with respect to the group of log entries; and
generating an input log entry assessment report that includes the input log entry classification.

9. The system of claim 8, further including processing the log entry with a one-class support vector machine (OCSVM) calibrated to consider a Mahalanobis Distance class boundary based, at least in part, on a principal component analysis of the group of log entries to generate a classification confidence rating for the input log entry classification; and
wherein the input log entry assessment report includes the classification confidence rating.

10. The system of claim 8, further including determining that at least one statistically significant input log feature occurs with a frequency below a preselected anomaly-indicating occurrence threshold by considering feature occurrence measurements selected from a group consisting of inverse frequency mapping, quantile transformation, and frequency mapping; and
wherein the input log entry assessment report includes the statistically significant input log feature.

11. The system of claim 8, further including, responsive to assigning the training log entry outlier status, receiving outlier status verification input and adjusting the outlier status in accordance therewith, wherein the outlier status verification input is selected from the group consisting of at least one predetermined assessment rule and log assessment input received from an analyst.

12. The system of claim 8, wherein the calibration of the group of unsupervised ML learning models to identify outliers within the log entry corpus accommodates a contamination value selected for each unsupervised ML learning model in accordance with a Mahalanobis Distance based, at least in part, on a principal component analysis of the group of log entries.

13. The system of claim of 8, wherein the group of unsupervised ML learning models is selected from the group consisting of self-organized maps, isolation forests, auto encoders, and Mahalanobis-distance-based algorithms.

14. The system of claim 8, wherein the supervised ML learning model is a random forest model.

15. A computer program product for device log entry assessment, the computer program product comprising a computer readable storage medium having program instructions embodied therewith, the program instructions executable by a computer to cause the computer to:
receive, using the computer, a preprocessed training log entry and a preprocessed input log entry from a log entry corpus containing a group of log entries representing data from communicatively connected devices available to the computer;
determine, using the computer, for the training log entry a group of outlier status indicators respective to the group of log entries based, at least in part, on processing the training log entry with a corresponding group of unsupervised Machine Learning (ML) learning models each calibrated to identify outliers within the log entry corpus;
responsive to recognizing that at least a threshold quantity of the outlier status indicators are substantially similar, assigning, using the computer, an outlier status based thereupon to the training log entry;
training, using the computer, a supervised ML learning model with a data pair including the training log entry and an associated data label representing the assigned outlier status value;
responsive to the training, processing, using the computer, the input log entry with the supervised ML learning model to predict a log classification for the input log entry, wherein the log classification indicates whether the input log is predicted to represent an anomaly with respect to the group of log entries; and
generating, using the computer, an input log entry assessment report that includes the input log entry classification.

16. The computer program product of claim 15, further including processing the log entry with a one-class support vector machine (OCSVM) calibrated to consider a Mahalanobis Distance class boundary based, at least in part, on a principal component analysis of the group of log entries to generate a classification confidence rating for the input log entry classification; and
wherein the input log entry assessment report includes the classification confidence rating.

17. The computer program product of claim 15, further including determining that at least one statistically significant input log feature occurs with a frequency below a preselected anomaly-indicating occurrence threshold by considering feature occurrence measurements selected from a group consisting of inverse frequency mapping, quantile transformation, and frequency mapping; and
wherein the input log entry assessment report includes the statistically significant input log feature.

18. The computer program product of claim 15, further including, responsive to assigning the training log entry outlier status, receiving outlier status verification input and adjusting the outlier status in accordance therewith, wherein the outlier status verification input is selected from the group consisting of at least one predetermined assessment rule and log assessment input received from an analyst.

19. The computer program product of claim 15, wherein the calibration of the group of unsupervised ML learning models to identify outliers within the log entry corpus accommodates a contamination value selected for each unsupervised ML learning model in accordance with a Mahalanobis Distance based, at least in part, on a principal component analysis of the group of log entries.

20. The computer program product of claim of 15, wherein the group of unsupervised ML learning models is selected from the group consisting of self-organized maps, isolation forests, auto encoders, and Mahalanobis-distance-based algorithms.
